(19) United States
(12) Patent Application Publication
(10) Pub. No.: US 2021/0154095 A1
(43) Pub. Date: May 27, 2021

(54) CONTAINER FOR PET PRODUCTS

(71) Applicant: FLP, LLC, Tempe, AZ (US)

(72) Inventor: Paul Croisdale, Tempe, AZ (US)

(73) Assignee: FLP, LLC, Tempe, AZ (US)

(21) Appl. No.: 16/692,897

(22) Filed: Nov. 22, 2019

(51) Int. Cl. A61J 1/03; B65D 41/04; B65D 41/62

(52) U.S. Cl. CPC A61J 1/03; B65D 41/62; B65D 41/04

(57) ABSTRACT

A container includes: (a) a first section having an outer surface, a stem having an outer surface, and a cavity, (b) a second section that has an interior pocket, and (c) a cap that has (i) an inner surface configured to be received on the outer surface of the stem, and an outer surface configured to be received in the interior pocket.

### TECHNICAL FIELD

This disclosure relates to containers for pet products, particularly tablets, capsules or other bite-sized products to be consumed by a pet.

### SUMMARY OF THE INVENTION

A container according to this disclosure generally comprises: (a) a first section having an outer surface, a stem having an outer surface, and a cavity, (b) a second section that has an interior pocket, and (c) a cap that has (i) an inner surface configured to be received on the outer surface of the stem, and an outer surface configured to be received in the interior pocket.

According to this disclosure, the cap that seals the container may be removed in two different ways. First, a user may unscrew the cap from the stem by turning the second section when the cap is positioned in the interior pocket of the second section. Because of an interface between the cap and the interior pocket, the cap turns as the second section is turned. The cap can be screwed back onto the stem by placing the second section back onto the first section. The respective configurations of the first section and second section align the cap with the stem. Then, by turning the second section, the cap is attached to the stem.

A user may instead remove the second section from the cap and then remove the cap from the stem by hand. The cap can then be reattached to the stem by hand.

Additionally, or alternatively, a container according to the invention may have multiple seals. When assembled, the cap is attached to the stem to seal the cavity of the first section. In one embodiment, when the second section is positioned on the first section, a first edge of the second section touches a first ledge of the first section, and a second edge of the second section touches a second ledge of the first section. This provides at least one optional seal in addition to the seal provided by the cap.

### BRIEF DESCRIPTION OF THE DRAWINGS

FIG. 1 is a side perspective view of a container in accordance with aspects of this disclosure.

FIG. 2 is an end view of the container of FIG. 1.

FIG. 3 is a side view of the container of FIG. 1.

FIG. 4 is perspective, side view of a first section of the container of FIG. 1 with a cap.

FIG. 5 is an end view of the first section of FIG. 4.

FIG. 6 is the opposite end view of the first section of FIG. 4.

FIG. 7 is a side view of the first section of FIG. 4.

FIG. 8 is a side, perspective of the first section of FIG. 4 with the cap off

FIG. 9 is a side view of the first section of FIG. 4 showing it being received in a second section.

FIG. 10 is a side, perspective, cut-away view of the container of FIG. 1.

FIG. 11 is a cross-sectional, side view of the first section of FIG. 4 without a cap.

FIG. 12 is a top view of the first section of FIG. 11.

FIG. 13 is a cross-sectional, side view of the container of FIG. 1.

FIG. 14 is a cross-sectional, side view of the first section of FIG. 4 with a cap.

FIG. 15 is a perspective, end view of the second section with a cap.

FIG. 16 is another perspective, end view of the second section of FIG. 15.

FIG. 17 is an end view of the second section of FIG. 15.

FIG. 18 is an end view showing the inside of the second section without a cap.

FIG. 18A is a side, cross-sectional view taken through line A-A of FIG. 18.

### DETAILED DESCRIPTION OF EMBODIMENTS

Turning now to the drawings, wherein the purpose is to describe embodiments of this disclosure, and not to limit the claims, a container 10 for products, such as pet vitamins, supplement, treats or food, is shown.

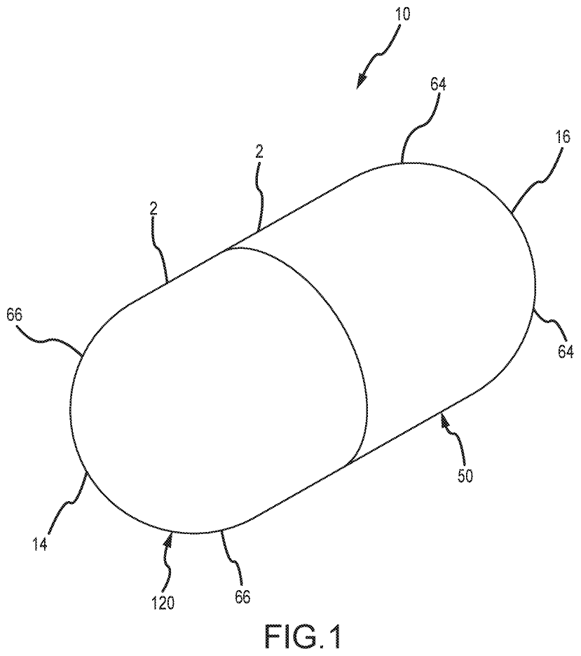

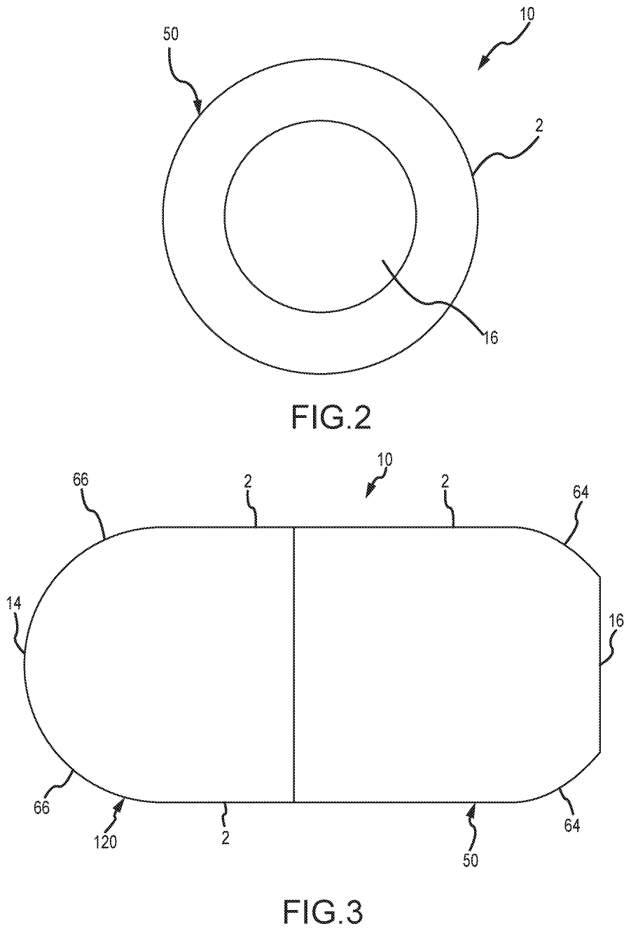

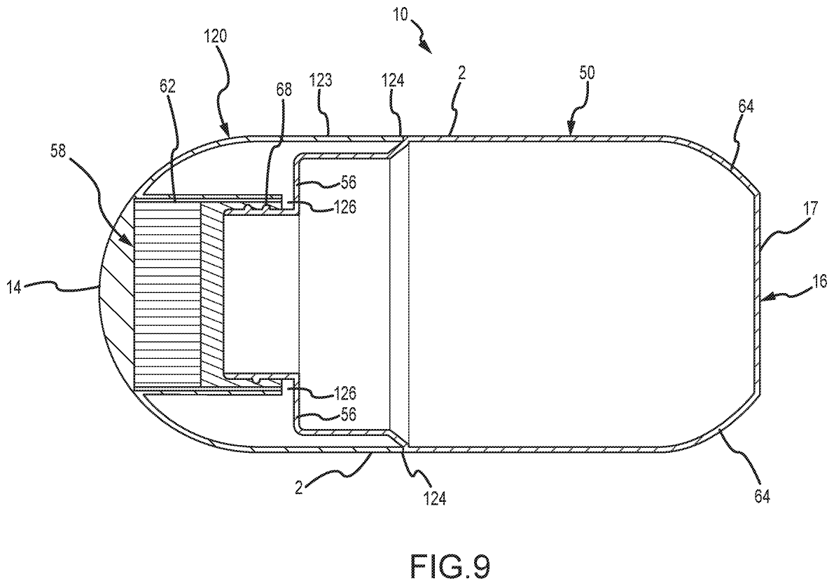

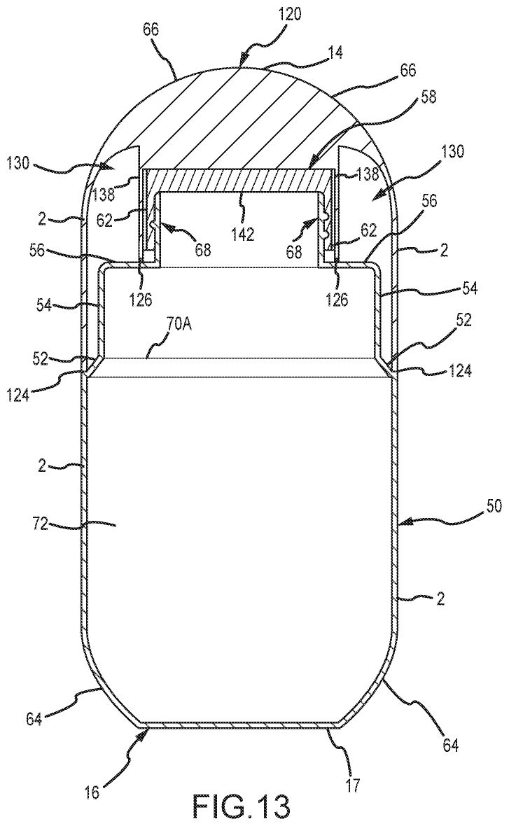

Container 10 comprises a first section 50, a second section 120 and a removeable cap 58. When assembled, as best seen in FIGS. 1-3, 9, and 13 container 10 has an annular outer surface 2 with a first end 14, and a generally flat, second end 16. Second end 16 is configured so that container 10 can stand (or be rested on) end 16 and any suitable configuration for this purpose would suffice.

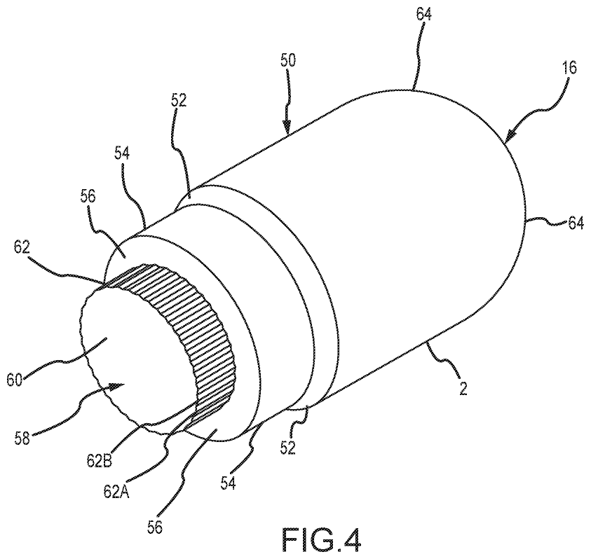

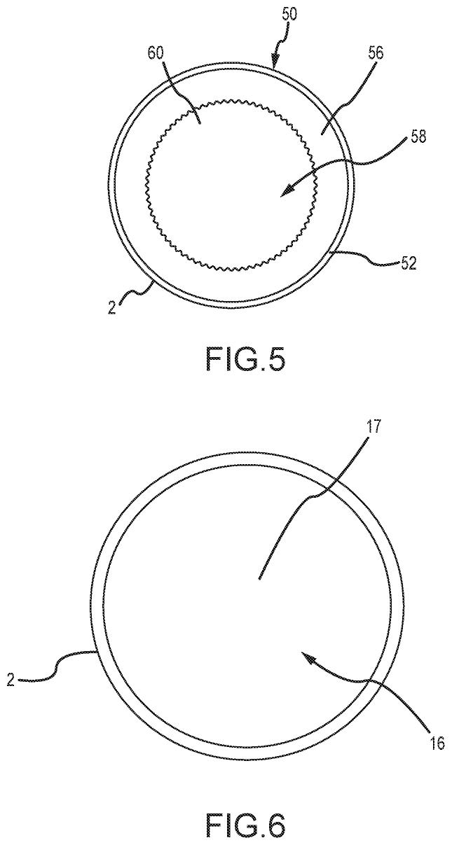

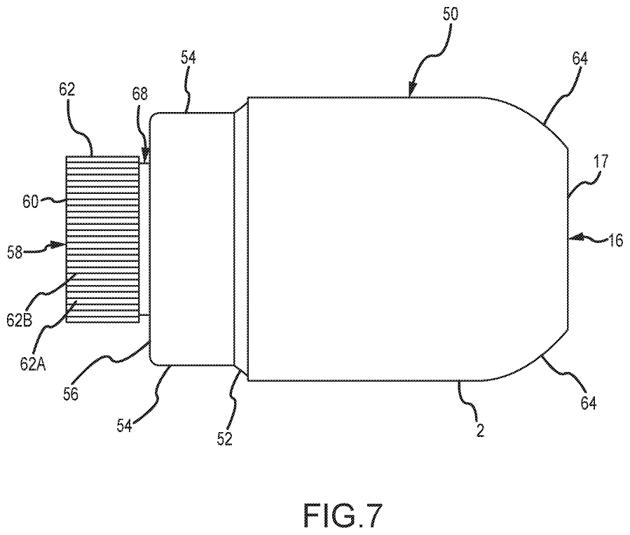

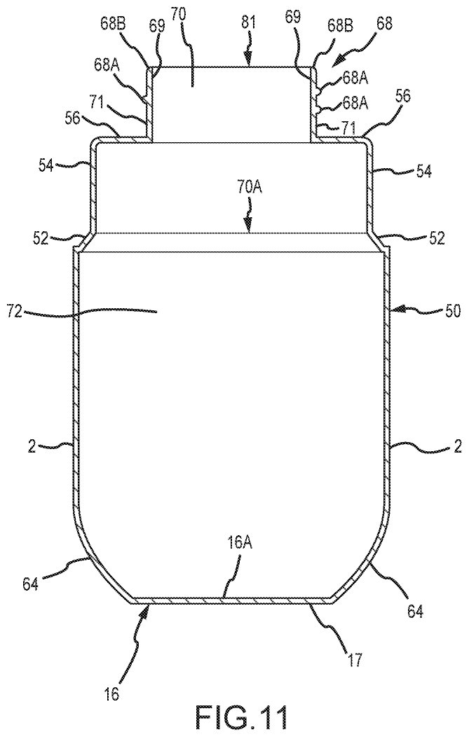

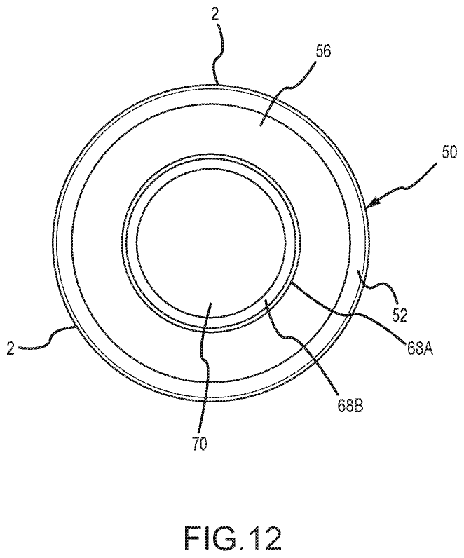

First section 50, as seen for example in FIGS. 4-8, and 11, includes part of annular outer body 2 with a first end 81 and a second end 16 with a distal, curved heel, or bottom portion 64 that includes a generally flat second or terminal portion 17. The second end 16 is configured so that container 10 can stand (or be rested) on the generally flat portion 17, and any suitable configuration of second end 16 would suffice for this purpose.

The first end 81 of the first section 50 includes a first annular shoulder, or ledge 52 extending to a first neck, or collar, 54 that extends to a second annular, shoulder, or ledge, 56 that extends inwardly to a stem 68.

As can be seen in FIGS. 4, 5 and 7, first shoulder 52 has an outer diameter generally equal to the diameter of annular outer surface 2, and an inner diameter generally equal to the diameter of the first neck 54. In this embodiment, the outer diameter of first shoulder 52 is greater than the outer diameter of second shoulder 56, and the inner diameter of first shoulder 52 is generally equal to the outer diameter of second shoulder 56. Second shoulder 56 has an outer diameter generally equal to the diameter of first neck 54 and an inner diameter preferably equal to the outer diameter of stem 68.

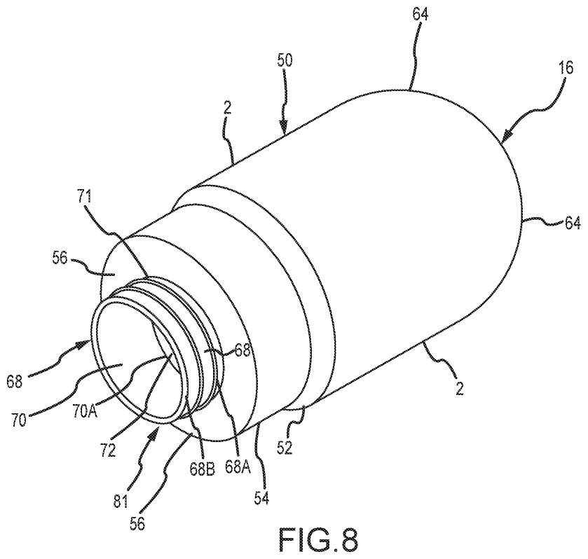

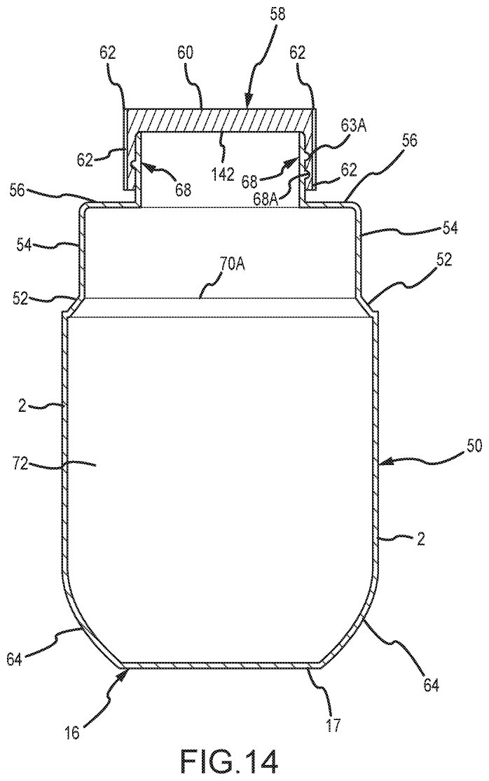

The stem 68, seen for example in FIGS. 8-9, 11, and 14, extends from the second shoulder 56 and is configured to removably attach to the removeable cap 58. In this embodiment, the stem 68 has an inner surface 69 and an outer surface 71. The outer surface 71 preferably includes a single continuous helical thread, or multiple helical threads, 68A, and a top edge 68B that defines an opening 70 that leads to an inner opening 70A, which provides access to an interior cavity 72. Cavity 72 is configured to retain product, such as vitamins, food, or medicine.

The removeable cap 58 includes a top surface 60 and an outer, annular side wall (or surface) 62. The side wall 62 as shown has ridges 62A that alternate with grooves 62B. Cap 58 has an inner, annular wall (or surface) 63 that is configured to attach to the outer, annular surface 71 of the stem 68, and a bottom, interior surface 142. In this embodiment cap inner surface 63 preferably includes a single continuous helical thread, or multiple helical threads, 63A that are configured to mate with thread(s) 68A.

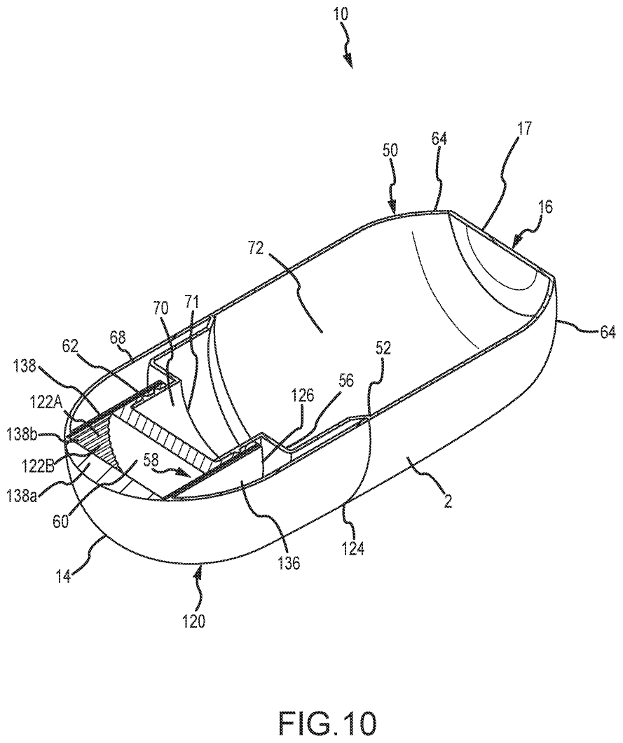

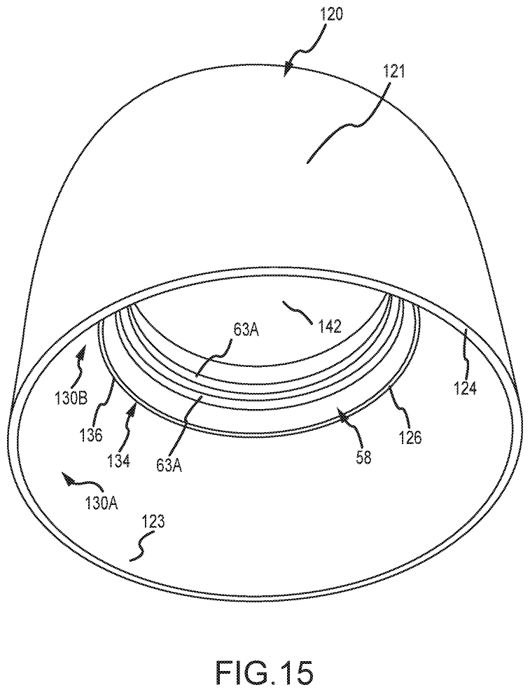

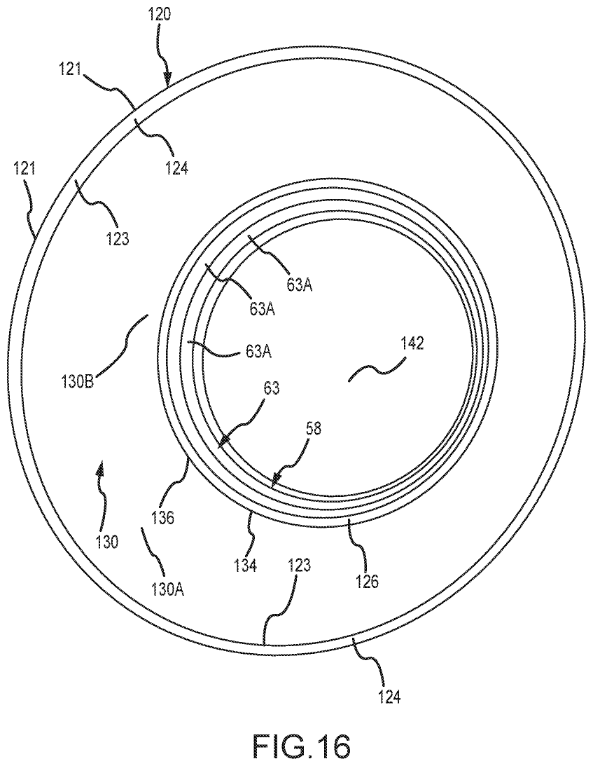

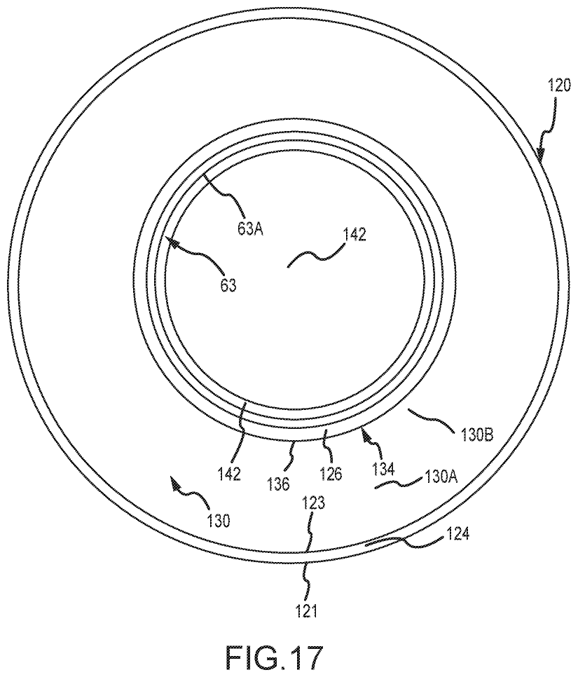

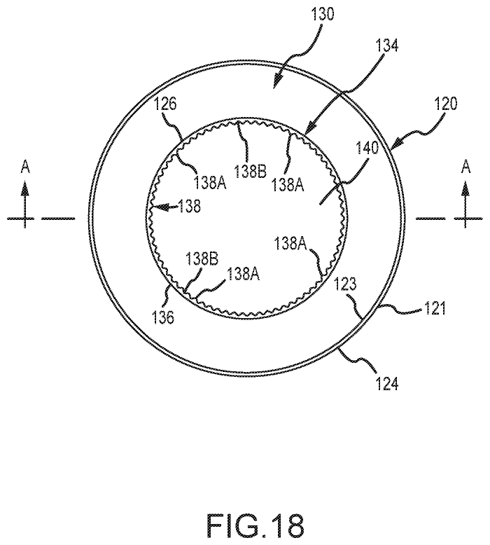

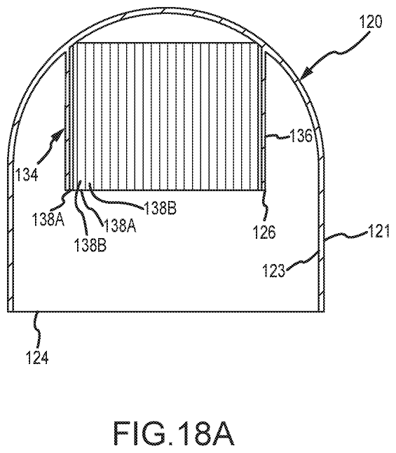

Second section 120, which is shown, for example, in FIGS. 1, 3, 10, and 15-19 has a curved top portion 66 that leads from annular outer surface 2 to end 14. End 14 as shown is rounded, but may be of any suitable shape. The second section 120 has an outer surface 121 and an inner surface 123, each of which terminates at a bottom edge 124. An interior space 130 of the second section 120 has a first portion 130A and a second, deeper portion 130B. An interior pocket 134 has an outer surface 136, an inner surface 138 with ridges 138A and grooves 138B, a base 140, and edge 126. Ridges and grooves 138A, 138B are configured to pressure fit with ridges 62A and grooves 62B of removable cap 58.

Interior pocket 134 has a depth that is preferably at least the same as the height of cap 58, and most preferably has a depth greater than the height of removeable cap 58. In this embodiment, interior pocket 134 is configured to receive at least part of stem 68 as well, and most preferably all of stem 68 so that edge 126 touches the second ledge 56 when container 10 is assembled.

When container 10 is fully assembled, removeable cap 58 is threadingly attached to the outer surface 71 of stem 68 and is received by interior pocket 134 of second section 120. In the embodiment shown, thread(s) 63A of the removable cap 58 is threaded onto thread(s) 68A of the stem 68 to seal the cavity 72 of container 10, although the removable cap 58 may be attached to stem 68 in any other suitable manner.

Preferably, when container 10 is fully assembled, second section 120 is positioned on first section 50 so that bottom edge 124 touches the first ledge 52, and the edge 126 touches the second ledge 56. Thus, this embodiment provides at least one seal in addition to the seal provided by cap 58, although the one or more additional seals are optional. Cap 58 is received in interior pocket 134 of second section 120 with ridges 62A received in grooves 138B, and ridges 138A received in grooves 62B.

In use, a user may unscrew removeable cap 58 from stem 68 in two different ways.

First, a user may unscrew the removable cap 58 from the stem 68 simply by rotating the entire second section 120. Because of the interface between the interior pocket ridges 138A and grooves 138B with the ridges 62A and grooves 62B, the removeable end cap 58 turns as second section 120 is turned. In this manner, when the removeable end cap 58 is removed from stem 68 it is retained in the inner pocket 134 of the second section 120. The removeable end cap 58 can be screwed back onto the stem 68 by placing second section 120 back onto first section 50. The respective configurations of the sections 50, 120 align removeable end cap 58 with stem 68. Then, by turning second section 120, removable end cap 58 can be screwed back onto stem 68.

Second, a user may remove end cap 58 by first removing second section 120 but leaving the removable cap 58 attached to the stem 68. The removable cap 58 can then be unscrewed from the stem 68 by hand. Cap 58 can then be screwed back onto stem 68 by hand.

Having thus described some embodiments of the invention, other variations and embodiments that do not depart from the spirit of the invention will become apparent to those skilled in the art. The scope of the present invention is thus not limited to any particular embodiment, but is instead set forth in the appended claims and the legal equivalents thereof. Unless expressly stated in the written description or claims, the steps of any method recited in the claims may be performed in any order capable of yielding the desired result.

What is claimed is:

1. A container comprising (a) a first section having an outer surface, a stem, and a cavity, (b) a second section that has an interior pocket that has an inner surface, and (c) a cap that has (i) an inner surface configured to be received and retained on the outer surface of the stem, and (ii) an outer surface configured to be received by the inside surface of the interior pocket of the second section.

2. The container of claim 1, wherein the first section further comprises an annular outer wall and the cavity comprises an annular wall.

3. The container of claim 1, wherein the second section has a length that is between 25%-50% of a length of the first section.

4. The container of claim 1, wherein the outer surface of the cap has alternating ridges and grooves.

5. The container of claim 1, wherein when the cap is attached to the stem.

6. The container of claim 5, wherein the second section is positioned on the first section.

7. The container of claim 6, wherein when the cap is positioned in the interior pocket.

8. The container of claim 1, wherein the first section further comprises a first ledge, and the second section further comprises a first edge configured to touch the first ledge when the second section is positioned on the first section.

9. The container of claim 8, wherein the first ledge is angled inward to help facilitate a pressure fit with the first ledge when the second section is positioned on the first section.

10. The container of claim 1, wherein the inner pocket has an annular, inner surface that includes alternating ridges and grooves.

11. The container of claim 10, wherein the outer surface of the cap includes alternating ridges and grooves that are configured to mate with the alternating ridges and grooves of the inner pocket.

12. The container of claim 1 that is comprised of plastic.

13. The container of claim 8, wherein the first section further comprises a second ledge and the second section further comprises a second edge that is configured to touch the second ledge when the second section is positioned on the first section.

14. The container of claim 1, wherein the inner surface of the cap is threaded and the outer surface of the stem is threaded and configured so that the cap can be threadingly received on the stem.

15. The container of claim 1 that further comprises a flat first end.
